(19) United States
(12) Patent Application Publication
(10) Pub. No.: US 2026/0262667 A1
(43) Pub. Date: Sep. 10, 2026

(54) METHOD OF PREPARING A PROTEIN DISH AND THE PRODUCT THEREOF

(71) Applicant: DIMITRIOS ZOURAS, NEA ERITHREA (GR)

(72) Inventor: DIMITRIOS ZOURAS, NEA ERITHREA (GR)

(21) Appl. No.: 19/165,730

(22) PCT Filed: Mar. 7, 2024
(86) PCT No.: PCT/GR2024/000009

§ 371 Date: Sep. 16, 2025

(30) Foreign Application Priority Data
Mar. 20, 2023 (GR) 20230100228

(51) Int. Cl. A23C 9/13; A23B 11/13

(52) U.S. Cl. CPC A23C 9/1315; A23B 11/13; A23C 9/1307

(57) ABSTRACT

The invention refers to a method of preparing a yogurt protein dish, to which egg protein, i.e. albumin, is added. The preparation method includes four stages, that is mixing and reconstitution, homogenization and low pasteurization, high pasteurization and finally incubation. The final product is enriched in milk protein and egg protein, is low in fat and does not contain lactose.

### THE FIELD OF ART

The invention refers to the field of human needs and specifically to the field of food, more specifically to the field of food and its production methods. It specifically refers to the field of dairy products and more specifically to the field of yogurt preparation. It specifically refers to a method of preparing a yogurt dish of high protein value, due to the addition of milk protein and egg protein, as well as to the product produced by said method.

### BACKGROUND OF THE INVENTION

The method disclosed in the present invention for the production of a high-protein yogurt dish, as well as the product produced by the specific method, have not been presented to date in the known state of the art.

The worldwide growing trend for a balanced and proper diet has led the dairy and especially yogurt market to look for alternative preparations that are rich in proteins. Proteins are one of the main features a balanced diet should include and is one of the features most consumers look for in the food they buy. Two of the most protein-rich foods are dairy and eggs. The amount of protein in dairy and especially yogurt can vary by yogurt type and brand, but in general, a cup of low-fat plain yogurt contains about 12-14 grams of protein. Greck yogurt, which is strained to remove some of the liquid whey and lactose, tends to be even higher in protein, with about 20 grams of protein per cup. Yogurt is also a good source of calcium and probiotics, which are beneficial for digestive system health. On the other hand, eggs are also high protein food, since a large egg usually contains about 6 grams of protein. The protein in eggs is considered high quality, meaning that it contains all the essential amino acids that the human body needs, but cannot produce on its own. So eating eggs can be a convenient and healthy way to add protein to people's diets.

Although milk protein and egg protein belong to the same family (α-globulins), they nevertheless have different amino acid profiles and different nutritional value. This is one of the reasons why it is not possible to combine the two products in one preparation to date. In practice, it has been observed that they operate competitively, with the result that the project cannot function productively. In yogurt production, the milk is heated to 90 degrees Celsius to activate the proteins and then culture is added and left to incubate and gradually cool to a pH 4,5 (slightly acidic). The addition of albumin (egg protein) affects the functioning of the culture and does not allow pH to drop to the desired 4,5, as a result of which production does not progress and therefore the yogurt dish does not coagulate. Another major problem is that albumin is heat-sensitive so it “coagulates” at high temperatures, such as 90° C., used to pasteurize yogurt. It was also observed that the addition of albumin also affects the enzyme lactase which is used to break down the lactose and produce a “lactose-free” formulation.

It is thus an object of the present invention to advantageously address the above-mentioned disadvantages and shortcomings of the prior art by proposing a production method for a high protein yogurt dish and the product produced.

It is a further object of the present invention to provide a method of producing an egg-combined yoghurt dish which is enriched in milk protein and egg protein, such as albumin.

It is a further object of the present invention to provide a high protein yogurt dish which is a complete meal for all age groups.

A further characteristic of the product produced by the method of producing high-protein yogurt dish is that it is also low in fat and does not contain lactose.

A further characteristic of the method for preparing the yogurt dish is that the egg protein is added together with the rest of the solids (milk powder, stabilizers) at a low temperature and then the mixture is heated gradually, indicatively in almost double the time, up to 90° C., so that the proteins are not “shocked” and coagulated before the pasteurization temperature.

A further advantage of the invention is that the mixture undergoes a double homogenization, gradually raising the temperature, in order to achieve the maximum dispersion of the protein in the mixture. The aim is to fully incorporate the albumin into the yogurt dish, so that it does not stand out from the cognate milk globulins.

These and other objects, features and advantages of the invention will become apparent in the following detailed description.

### DETAILED DESCRIPTION OF A PREFERRED EMBODIMENT

The description that follows, with reference to an application example of the protein preparation method and its produced product, aims to present in detail both the method application and the advantages presented by the final prepared product.

The method for preparing the yogurt dish includes four steps with a first mixing and reconstitution step, followed by homogenization and low pasteurization, high pasteurization and finally incubation. First, the milk, skimmed or non-fat, milk protein concentrate (MPC), stabilizer, modified starch, lactase and gelatin are mixed into powder. Water is added to the mixture and stirred. The mixture is sent to a mixer, an exchanger and a boiler, for the purpose of reconstitution.

In the homogenization and low pasteurization stage, vegetable fat is added, preferably walnut oil, and the mixture through the heat exchanger rises to 52° C. and is enriched with the egg protein, i.e. albumin, before being sent to a homogenizer. The homogenization process initially requires maintaining the temperature and gradually increasing the pressure to 240 bar, in order for the liposomes of the vegetable fats to join during the reconstitution and create an emulsion containing milk and albumin. The homogenization process is repeated once more, under the same conditions.

The pasteurization stage follows, wherein the temperature of the mixture increases to 90° C. for a specific period of time, preferably minutes, in order to stabilize and pasteurize. It is then sent to the heat exchanger, in order to reduce its temperature, preferably to 42° C., followed by storage in a tank.

In the final stage the mixture is enriched with culture and remains in the incubation tank for a period of time, not less than 12 hours. During this time the culture works, the product coagulates to create the yogurt dish, while at the same time its active acidity is reduced to 4.5 pH.

According to the above method of preparing the high-protein yogurt dish, a product is prepared which consists of milk powder, in percentages of 5-12%, in particular an average of 7%, concentrated milk protein, in percentages of 7-13%, in particular an average of 8%, stabilizer, modified starch in an indicative percentage of 1%, lactase, gelatin in an indicative percentage of 0.5%, water, walnut oil in percentages of 3-10%, in particular an average of 5%, and egg protein, i.e. albumin, at a rate of at least 0.3%.

In an alternative embodiment of the invention the vegetable fat used, i.e. walnut oil, may be replaced by animal fat, without any further change in the composition or the method of preparation and thus result in a yogurt dessert of high protein value.

It should be noted here that the description of the invention has been made with reference to illustrative embodiments to which it is not limited. Likewise, any change or modification in terms of shape, dimensions, morphology, materials used and construction and assembly components, as long as they do not constitute a new inventive step and do not contribute to the technical development of what is already known, are considered included in the aims and objectives of the present invention as summarized in below claims.

1. A method of preparing a yogurt protein dish, consisting of a mixing and reconstitution stage, wherein milk powder, milk protein, stabilizer, modified starch, lactase and gelatin are stirred and mixed with water and reconstituted, a homogenization and low pasteurization stage, wherein vegetable fats are added to the mixture and its temperature is increased to 52° C., a high pasteurization stage, wherein the temperature of the mixture is raised to 90° C., for 5 minutes and then allowed to cool to 42° C., and an incubation stage, wherein the mixture is enriched with culture and left in an incubation tank for at least 12 hours to coagulate, characterized in that during the homogenization and low pasteurization stage, the mixture, under a constant temperature of 52° C., is pressured up to 240 bar and egg protein is added to create an emulsion.

2. A method of preparing a yogurt protein dish, according to claim 1. wherein walnut oil is used as vegetable fat.

3. A method of preparing a yogurt protein dish, according to claim 1, wherein albumin is used as egg protein.

4. Protein dish, consisting of milk powder, concentrated milk protein, stabilizer, modified starch, lactase, gelatin, water, walnut oil and characterized by having egg protein, at least 0.3% of the final mixture.
